(19) United States
(12) Patent Application Publication
(10) Pub. No.: US 2018/0274445 A1
(43) Pub. Date: Sep. 27, 2018

(54) Inlet Bleed Heat Duct Assembly

(71) Applicant: General Electric Company, Schenectady, NY (US)

(72) Inventors: Haribalakrishnan Sankarakumar, Bangalore (IN); Pradeeba Duraiswamy, Bangalore (IN); Bradly Aaron Kippel, Greer, SC (US)

(21) Appl. No.: 15/464,839

(22) Filed: Mar. 21, 2017

(51) Int. Cl. F02C 7/08; F02C 7/04; F02C 7/045

(52) U.S. Cl. CPC F02C 7/08; F02C 7/045; F02C 7/04

(57) ABSTRACT

A compressor inlet housing includes a bleed heat duct assembly that is disposed within the compressor inlet housing. The bleed heat duct assembly includes a duct having a plurality of walls defining an opening and a slot defined along a wall of the plurality of walls. The bleed heat duct further includes a bleed air manifold and a plurality of feed pipe assemblies that is disposed at least partially within the opening and that is in fluid communication with the bleed air manifold. Each feed pipe assembly of the plurality of feed pipe assemblies includes an inner pipe having an upstream end connected to the bleed air manifold, a cap sealingly connected to a downstream end of the inner pipe and a pin that extends outwardly from the cap. The pin extends into the slot.

### FIELD OF THE TECHNOLOGY

This disclosure relates to an inlet bleed heat system for a gas turbine and, more particularly, to an inlet bleed heat duct assembly of the inlet bleed heat system.

### BACKGROUND

A combustion system of a gas turbine generates hot gases to drive a turbine. The turbine, in turn, drives a compressor that provides compressed air for combustion in the combustion system. The turbine produces usable output power. In some gas turbine applications, there are instances of gas turbine plant operation where the gas turbine pressure ratio reaches the operating pressure ratio limit of the compressor, resulting in compressor surge. These instances may arise in applications where low energy fuels or any other fuels with large amounts of diluent injection are used and/or at cold ambient temperature conditions. The compressor pressure ratio is typically larger than the turbine pressure ratio in that the latter is subject to pressure loss in the turbine combustor.

One solution that has been used to provide compressor pressure ratio protection is the bleeding off of gas turbine compressor discharge air and re-circulating the bleed air back to the compressor inlet. This method of gas turbine operation, known as inlet bleed heat control, raises the inlet temperature of ambient air entering the compressor inlet by mixing the bleed portion of the hot compressor discharge air with the colder ambient air, thereby reducing the air density and the mass flow to the gas turbine.

In a typical inlet bleed heat system, the extracted bleed air is routed to a bleed air manifold which feeds multiple feed pipes. The feed pipes extend across an inlet duct of the inlet bleed heat system. Each feed pipe includes a number of orifices distributed along their length and formed to deliver the extracted bleed air to the flow of ambient air upstream from the compressor inlet. In order to attenuate noise generated by the jets of bleed air exiting the orifices, the feed pipes typically have acoustical nozzles over the orifices to attenuate this noise. The mesh material acts to attenuate the noise such that the inlet bleed heat system can be positioned upstream of an inlet silencer.

Due to a large temperature differential between the ambient air and the bleed air, the bleed air manifold and the feed pipes expand and contract. The bleed air manifold and the feed pipes grow or translate both laterally and vertically with respect to each other and with respect to the inlet duct. As a result, stresses may occur at various joints formed between the respective feed pipes and the bleed air manifold.

### BRIEF DESCRIPTION

Aspects and advantages are set forth below in the following description, or may be obvious from the description, or may be learned through practice.

One embodiment of the present disclosure is compressor inlet housing including a bleed heat duct assembly disposed within the compressor inlet housing. The bleed heat duct assembly includes a duct having a plurality of walls defining an opening where the duct includes a slot defined along a wall of the plurality of walls. The bleed heat duct assembly further includes a bleed air manifold and a plurality of feed pipe assemblies disposed at least partially within the opening and in fluid communication with the bleed air manifold. Each feed pipe assembly of the plurality of feed pipe assemblies includes an inner pipe having an upstream end that is connected to the bleed air manifold, a cap that is sealingly connected to a downstream end of the inner pipe and a pin that extends outwardly from the cap. The pin extends into the slot.

Another embodiment of the present disclosure is a compressor inlet housing including a bleed heat duct assembly disposed within the compressor inlet housing. The bleed heat duct assembly includes a duct having a plurality of walls defining an opening where the duct includes a slot defined along a wall of the plurality of walls. The bleed heat duct assembly further includes a bleed air manifold and a plurality of feed pipe assemblies disposed at least partially within the opening and in fluid communication with the bleed air manifold. Each feed pipe assembly of the plurality of feed pipe assemblies includes an inner pipe having an upstream end that is connected to the bleed air manifold and a cap that is sealingly connected to a downstream end of the inner pipe. An outer sleeve surrounds at least the downstream end of the of the feed pipe assembly. The outer sleeve has an end plate and a pin that extends outwardly from the end plate. The pin extends into the slot.

Those of ordinary skill in the art will better appreciate the features and aspects of such embodiments, and others, upon review of the specification.

### BRIEF DESCRIPTION OF THE DRAWINGS

A full and enabling disclosure of various embodiments, including the best mode thereof to one skilled in the art, is set forth more particularly in the remainder of the specification, including reference to the accompanying figures, in which:

FIG. 1 is a schematic illustration of an exemplary inlet bleed heat system as may incorporate various embodiments of the present disclosure;

FIG. 2 is a perspective side view of an exemplary bleed heat duct assembly according to one embodiment of the present disclosure;

FIG. 3 is an upstream view of the bleed heat duct assembly as shown in FIG. 2;

FIG. 4 is a perspective side view of an exemplary bleed heat duct assembly according to at least one embodiment of the present disclosure;

FIG. 5 provides a downstream view of the bleed heat duct assembly as shown in FIG. 4;

FIG. 6 is a downstream view of a partially assembled feed pipe assembly according to at least one embodiment of the present disclosure;

FIG. 7 is a downstream view of the feed pipe assembly as shown in FIG. 6, according to at least one embodiment of the present disclosure;

FIG. 8 is a perspective view of a portion of an inner pipe according to at least one embodiment of the present disclosure;

FIG. 9 is a cross-sectioned view of a portion of the inner pipe shown in FIG. 8;

FIG. 10 is a perspective view of a portion of a bleed heat duct assembly according to at least one embodiment of the present disclosure;

FIG. 11 is an enlarged view of a first end of the feed pipe assembly as shown in FIG. 10, according to at least one embodiment;

FIG. 12 provides an enlarged view of a second end of the feed pipe assembly as shown in FIG. 10, according to at least one embodiment;

FIG. 13 provides a cross-sectioned side view of a portion of the bleed heat duct assembly as shown in FIG. 12, according to at least one embodiment

FIG. 14 is a perspective view of a portion of a bleed heat duct assembly according to at least one embodiment of the present disclosure;

FIG. 15 provides an enlarged view of a first end of the feed pipe assembly as shown in FIG. 14, according to at least one embodiment; and

FIG. 16 provides an enlarged view of a second end of the feed pipe assembly as shown in FIG. 14, according to at least one embodiment.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

As used herein, the terms “first,” “second,” and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows. The term “laterally” may be defined as a side-to-side or wall-to-wall direction between two parallel walls of a corresponding duct assembly.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Each example is provided by way of explanation, not limitation. In fact, it will be apparent to those skilled in the art that modifications and variations can be made without departing from the scope or spirit thereof. For instance, features illustrated or described as part of one embodiment may be used on another embodiment to yield a still further embodiment. Thus, it is intended that the present disclosure covers such modifications and variations as come within the scope of the appended claims and their equivalents. Although exemplary embodiments of the present disclosure will be described generally in the context of an inlet bleed heat system for a land based power generating gas turbine for purposes of illustration, one of ordinary skill in the art will readily appreciate that embodiments of the present disclosure may be applied to any style or type of turbomachine and are not limited to combustors or combustion systems for land based power generating gas turbines unless specifically recited in the claims.

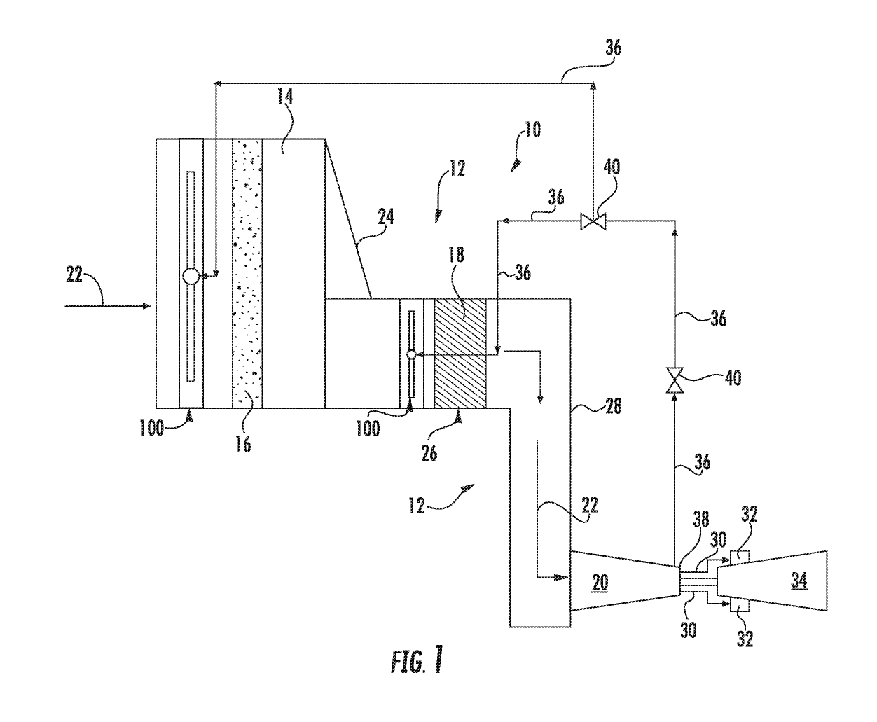

FIG. 1 provides a schematic illustration of an exemplary inlet bleed heat system 10 as may incorporate various embodiments of the present disclosure. Inlet bleed heat (IBH) system 10 may be used to protect a gas turbine compressor from icing when operating at reduced inlet guide vane (IGV) angles. Moreover, IBH system 10 may be used to reduce compressor pressure ratio at certain operating conditions where additional compressor operating margin is required.

As illustrated in FIG. 1, the inlet bleed heat system 10 may be part of a compressor inlet housing 12, and may include an inlet filter housing 14, which may include one or more filters 16, and an inlet silencer 18 disposed downstream of the inlet filter housing 14. In operation, a compressor 20 draws air 22 into the inlet filter housing 14. A transition duct 24 may fluidly couple the inlet filter housing 14 to a duct 26 in which inlet silencer 18 is disposed. Additional ducts 28 may be disposed downstream from the inlet silencer 18 and provide for fluid flow between transition duct 24 and an inlet to the compressor 20.

In the example shown in FIG. 1, the compressor 20 feeds compressed air 30 to a combustion section 32 of a gas turbine 34. Compressor discharge air 36 is routed from an extraction port 38 defined along an outer casing of the compressor 20 through a number of conduits and valves 40, such as an isolation valve and a control valve, to a bleed heat duct assembly 100 which is disposed within the compressor inlet housing 12. In particular embodiments, the bleed heat duct assembly 100 may be positioned within the compressor inlet housing 12 upstream from the one or more filters 16. In particular embodiments, the bleed heat duct assembly 100 may be positioned within the compressor inlet housing 12 between the inlet filter housing 14 and the compressor 20. The exact positioning of the bleed heat duct assembly 100 may vary within the compressor inlet housing 12.

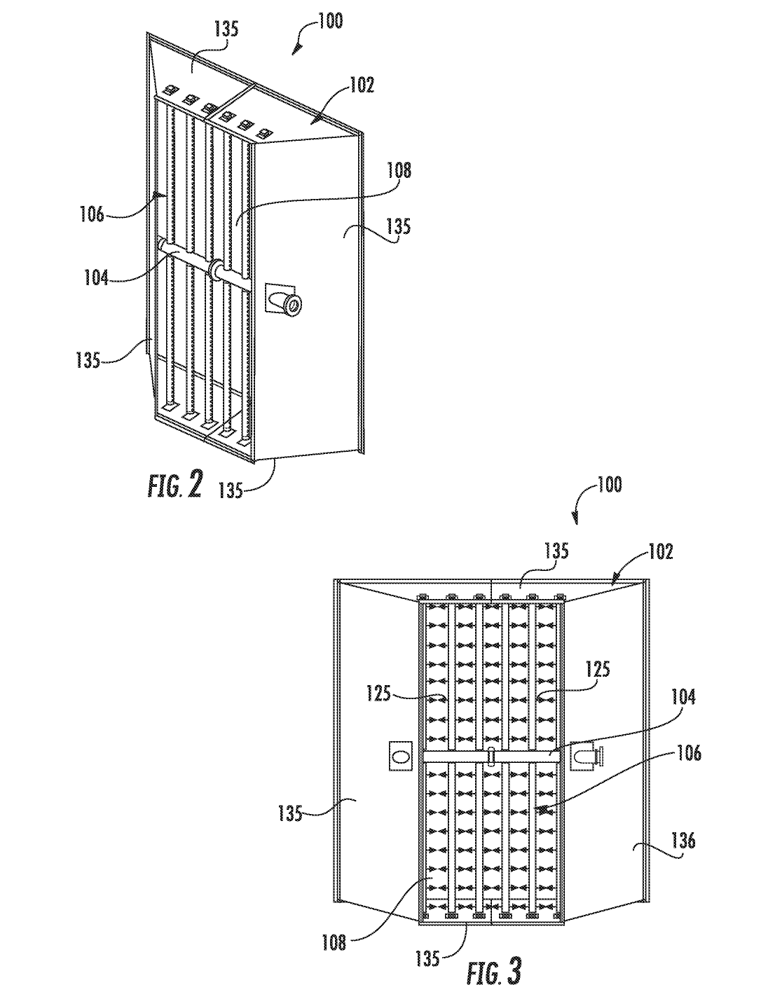

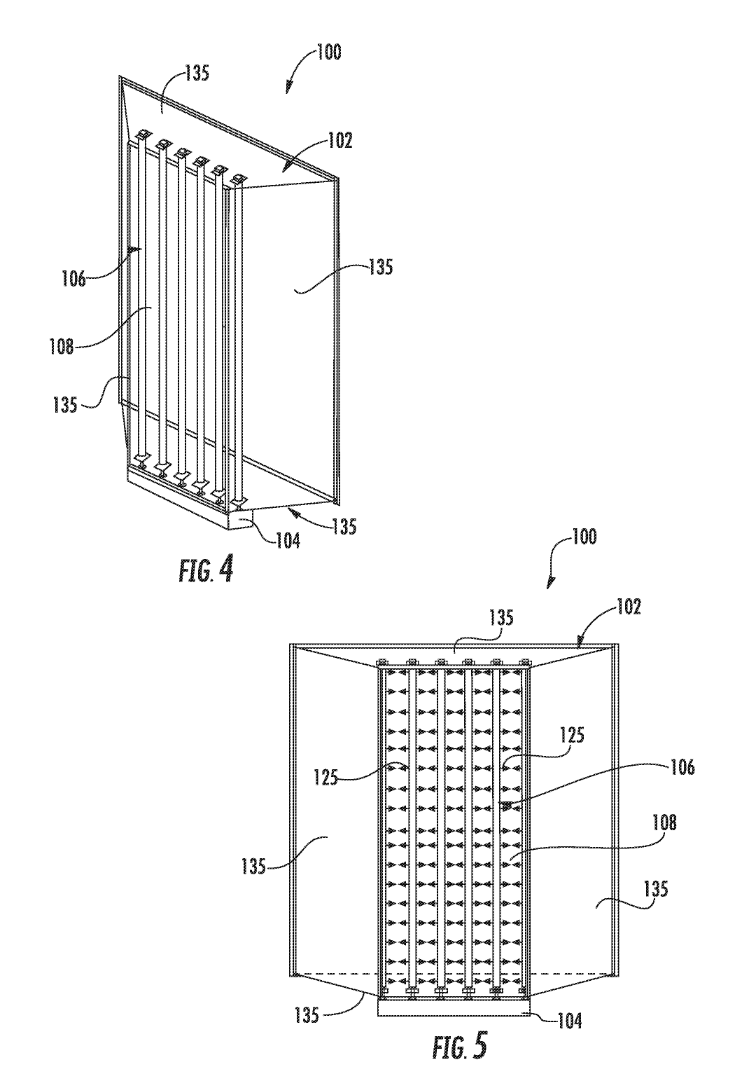

FIG. 2 provides a perspective side view of an exemplary bleed heat duct assembly 100 according to one embodiment of the present disclosure. FIG. 3 provides an upstream view of the bleed heat duct assembly 100 as shown in FIG. 2. FIG. 4 provides a perspective side view of an exemplary bleed heat duct assembly 100 according to one embodiment of the present disclosure. FIG. 5 provides a downstream view of the bleed heat duct assembly 100 as shown in FIG. 4.

In accordance with various embodiments of the present disclosure as shown in FIGS. 2, 3, 4 and 5 collectively, the bleed heat duct assembly 100 includes a duct 102, a bleed air manifold 104 that is in fluid communication with the extraction port 38 (FIG. 1) via various pipes, couplings and/or valves, and a plurality of feed pipe assemblies 106 connected to the bleed air manifold 104 and that extend across an opening 108 defined by the duct 102. The opening 108 provides for fluid communication between the inlet filter housing 14 and the compressor 20. Each feed pipe assembly 106 is in direct fluid communication with the bleed air manifold 104. The bleed air manifold 104 may be fixed or secured in position at a first end while a second end of the bleed air manifold 104 is unrestrained to allow for thermal growth thereof.

As understood, the exact number of feed pipe assemblies 106 that are necessary for a particular application may vary depending on a number of factors such as but not limited to: desired airflow temperature and pressure, mixing limitations, duct size, compressor size, compressor discharge air temperature and pressure, etc. Feed pipe assemblies 106 may extend within the opening 108 in a manner other than vertically as illustrated. In particular embodiments, as shown in FIGS. 2 and 3, the bleed air manifold 104 may be positioned at any vertical location within the opening 108. In particular embodiments, as shown in FIGS. 2 and 3, a first set of feed pipe assemblies of the plurality of feed pipe assemblies 106 may extend in a first direction (upwardly) from the bleed air manifold 104 while a second set of feed pipe assemblies of the plurality of feed pipe assemblies 106 may extend in a second or opposite direction (downwardly) from the bleed air manifold 104. In other embodiments, the plurality of feed pipe assemblies 106 may extend substantially horizontally across the opening 108. In at least one embodiment, as shown in FIGS. 4 and 5, the bleed air manifold 104 may be positioned outside of the duct 102 and/or the opening 108 or adjacent to a wall of the duct.

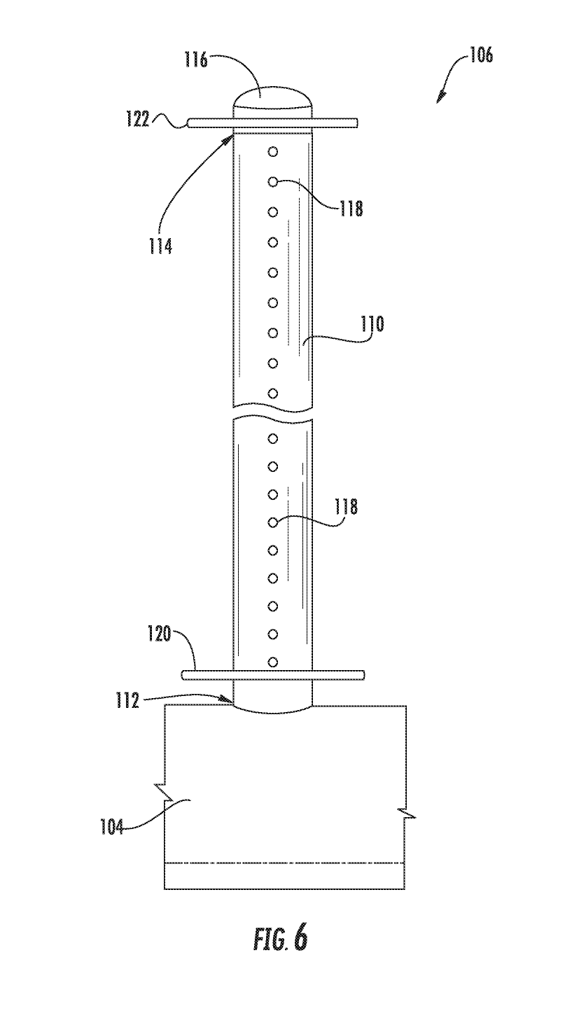

FIG. 6 provides a downstream view of a partially assembled feed pipe assembly 106 according to at least one embodiment of the present disclosure. In particular embodiments, as shown in FIG. 6, the feed pipe assembly 106 includes an inner or first pipe 110 having an upstream or first end 112 that is connected to the bleed air manifold 104 and a downstream or second end 114 that terminates distal and downstream from the bleed air manifold 104. In particular embodiments, the downstream end 114 may be sealed with a cap 116.

The inner pipe 110 is in direct fluid communication with the bleed air manifold 104. The inner pipe 110 defines a plurality of apertures 118 which is distributed along the length of the inner pipe 110. The apertures 118 provide for fluid communication from the bleed air manifold 104 and out of the inner pipe 110. The inner pipe 110 may be made of any material capable of withstanding the environment within compressor inlet housing 12, e.g., steel, aluminum, alloy, etc., and may have diameter in the range of approximately 1 inch to approximately 24 inches.

In particular embodiments, the feed pipe assembly 106 may include a first flange 120 disposed proximate to the upstream end 112 of the inner pipe 110 and that extends at least partially circumferentially around the inner pipe 110. The feed pipe assembly 106 may also include a second flange 122 disposed proximate to the downstream end 114 of the inner pipe 110 and that extends at least partially circumferentially around the inner pipe 110.

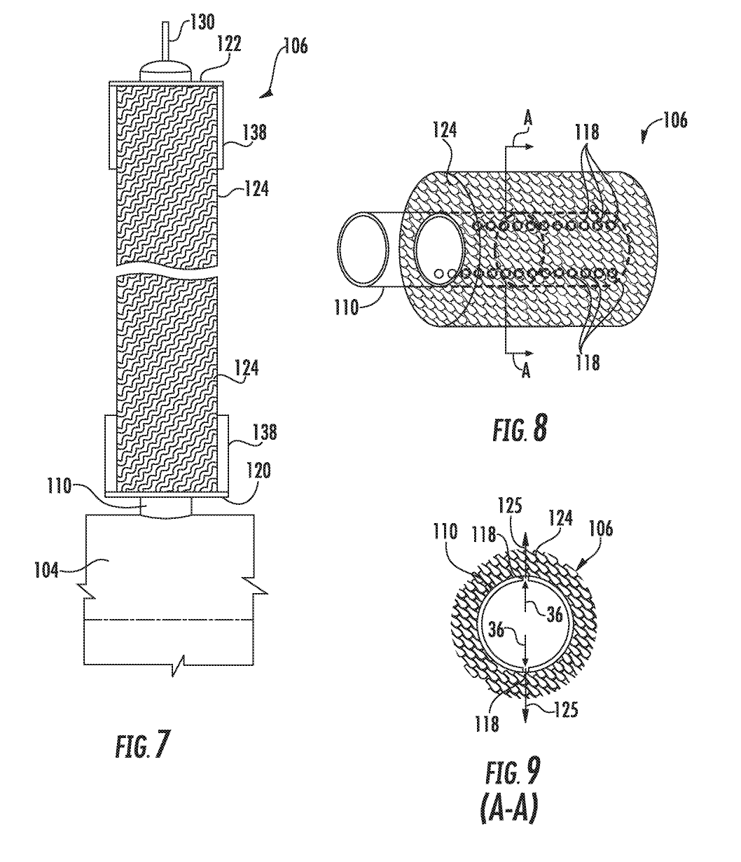

FIG. 7 provides a downstream view of the feed pipe assembly 106 as shown in FIG. 6, according to at least one embodiment of the present disclosure. FIG. 8 provides a perspective view of a portion of the inner pipe 110 according to at least one embodiment of the present disclosure. FIG. 9 provides a cross-sectioned view of the portion of inner pipe 110 shown in FIG. 8. In particular embodiments, as shown in FIGS. 7, 8 and 9 collectively, the feed pipe assembly 106 may include a noise attenuating material 124 which at least partially surrounds or is wrapped around at least a portion of the apertures 118 of the plurality of apertures 118.

In particular embodiments, as shown in FIGS. 8 and 9, the noise attenuating material 124 may be used on a portion of the inner pipe 110 that is exposed to the opening 108 such that attenuated compressor discharge air 125 simply passes through apertures 118 of the inner pipe 110 and passes through the noise attenuating material 124 into the opening 108. In particular embodiments, at least one of the first flange 120 and the second flange 122 may constrain or hold the noise attenuating material 124 in place.

The noise attenuating material 124 may include any material configured to attenuate noise created by the compressor discharge air 36 exiting the orifices 118, and capable of withstanding the environment within the compressor inlet housing 12. In one embodiment, noise attenuating material 124 may include a tangled, matted or meshed metal such as but not limited to a metal wire mesh. In the latter example, noise attenuating material 124 may include, for example, a metal wire mesh tape such as but not limited to corrosion-resistant metal gauze (e.g., 304 stainless steel) available from McMaster-Carr, Atlanta, Ga. The metal wire mesh tape may be rolled about feed pipe assembly 106 in such a manner as to selectively provide a particular meshed metal density and radial depth.

The density and depth or thickness may be chosen to accommodate different applications. For example, the metal wire mesh may have a radial thickness ranging from approximately 0.5 inches to approximately 6 inches. Similarly, the metal wire mesh may have a density ranging from approximately 50 kg/m³ to approximately 1000 kg/m³. The density may be substantially radially uniform or may vary over the thickness. With certain embodiments, noise reduction has been observed up to approximately 30 decibels (dB). Other noise attenuating material may also be employed such as steel wool, matted steel shavings, non-tape metal wire mesh, etc. Combinations of the above-identified examples may also be employed, e.g., steel wire mesh with steel wool. Any material used is, ideally, although not necessarily, wrapped about inner pipe 110 in a manner to ensure even distribution during operation of the compressor.

During operation, a large temperature differential between the ambient air 22 entering the compressor inlet housing 12 and the compressor discharge air 36, the bleed air manifold 104 and the feed pipe assemblies 106 expand and contract both laterally and vertically with respect to each other and with respect to the duct 102 of the bleed heat duct assembly 100. As a result, stresses may occur at various joints formed between the respective feed pipes and the bleed air manifold, and the outer sleeve 138.

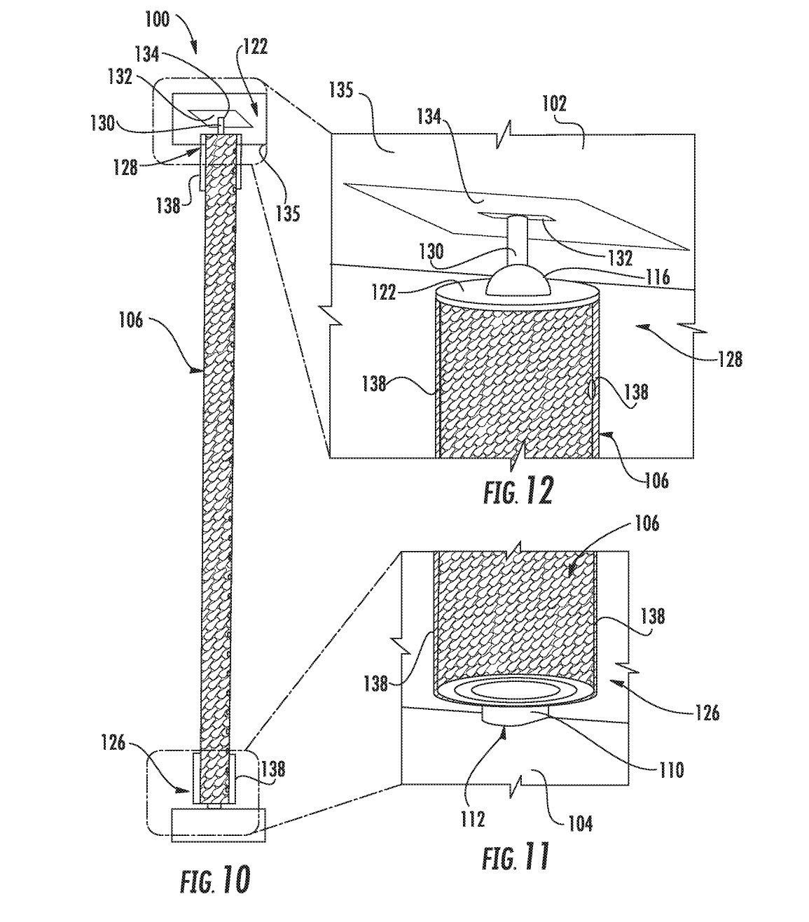

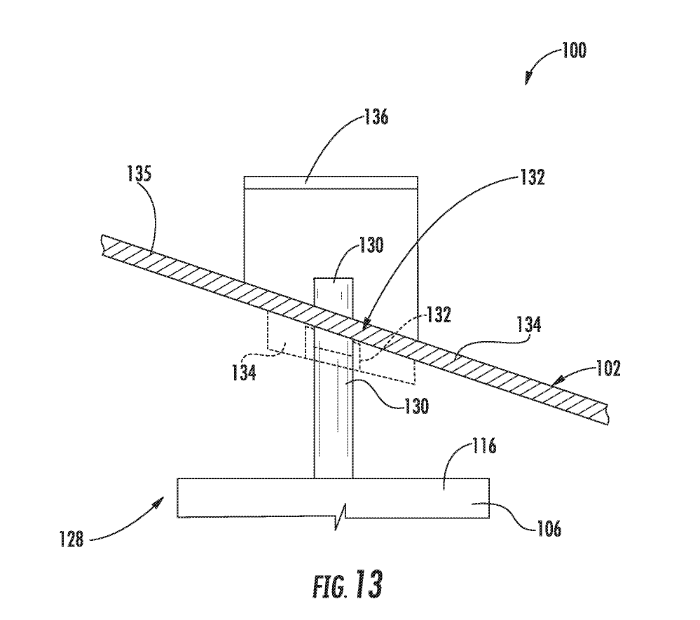

FIG. 10 provides a perspective view of a portion of the bleed heat duct assembly 100 according to at least one embodiment of the present disclosure. FIG. 11 provides an enlarged view of a first end 126 of the feed pipe assembly 106 as shown in FIG. 10 according to at least one embodiment. FIG. 12 provides an enlarged view of a second end 128 of the feed pipe assembly 106 as shown in FIG. 10, according to at least one embodiment. FIG. 13 provides a cross-sectioned side view of a portion of the bleed heat duct assembly 100 as shown in FIG. 12, according to at least one embodiment.

As previously described, and as shown in FIGS. 10 and 11 collectively the upstream end 112 of the inner pipe 110 and/or the first end 126 of the feed pipe assembly 106 is joined to the bleed air manifold 104. In particular embodiments, as shown in FIGS. 10, 12 and 13 collectively, a projection or pin 130 extends outwardly from the cap 116 and/or the second end 128 of the feed pipe assembly 106 into a slot 132 defined or provided in a support plate 134 and/or a wall 135 of the duct 102. The slot 132 may be oriented laterally to allow for lateral or side to side thermal growth of the bleed air manifold 104 with respect to the duct 102. In order to accommodate for the relative vertical thermal expansion, as shown in FIG. 13, the pin 130 extends vertically through the slot 132, thereby allowing the pin to translate vertically within the slot during vertical expansion and contraction of the feed pipe assembly 106.

In particular embodiments, as shown in FIG. 13, the pin 130 may extend through the duct 102 and/or the support plate 134 and into a housing 136 positioned along a backside of the duct 102. The housing 136 may prevent air from flowing out of the duct 102 during operation. In particular embodiments, the plate 134 may be disposed along an inner surface of the duct 102 or otherwise disposed within the opening 108 such that the pin 130 may move vertically without penetrating the duct 102, thereby sealing the duct 102.

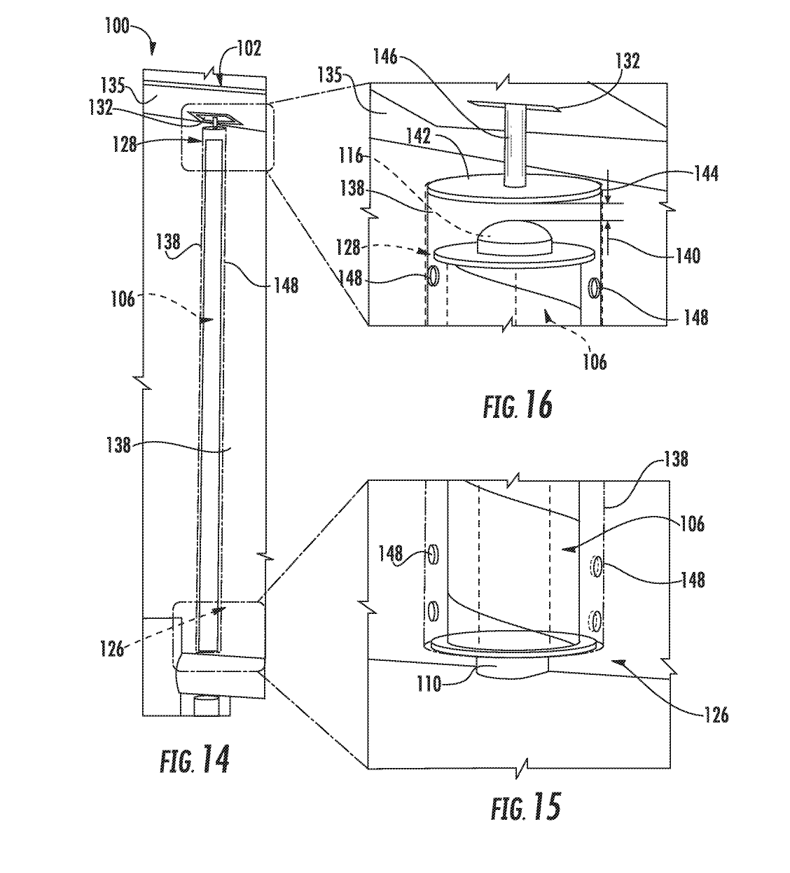

FIG. 14 provides a perspective view of a portion of the bleed heat duct assembly 100 according to at least one embodiment of the present disclosure. FIG. 15 provides an enlarged view of the first end 126 of the feed pipe assembly 106 as shown in FIG. 14 according to at least one embodiment. FIG. 16 provides an enlarged view of the second end 128 of the feed pipe assembly 106 as shown in FIG. 14, according to at least one embodiment.

In particular embodiments, as shown in FIGS. 7 through 12 and 14, 15 and 16 collectively, at least a portion of the feed pipe assembly 106 may be disposed within an outer sleeve 138. In one embodiment, both the first flange 120 and the second flange 122 may be disposed within the outer sleeve 138. In one embodiment, as shown in FIG. 16, the second flange 122 may be positioned within the outer sleeve 138 and a gap 140 may be defined between the cap 116 of the feed pipe assembly 106 and an end plate 142 that extends across an end 144 of the outer sleeve 138. A pin or projection 146 extends outwardly from the end plate 142 into the slot 132. The slot 132 is oriented laterally to allow for lateral or side to side thermal growth of the bleed air manifold 104 with respect to the duct 102.

The outer sleeve 138 may contain at least a portion of the acoustic attenuating material 106 such that it does not come lose which may result in turbine damage and/or loss of acoustic attenuation. The outer sleeve 138 is decoupled from the transient thermal growth of both the inner pipe 116 and the pipe header 104. This allows the system to not crack/fail during these thermal transients.

During operation, the second flange 122 may move vertically within the outer sleeve 138 as the feed pipe assembly 106 expands and contracts vertically due to thermal variants. The gap 140 prevents contact between the feed pipe assembly 106 and the end plate 142 during vertical expansion and contraction of the feed pipe assembly 106. In particular embodiments, the outer sleeve 138 may define one or more ports 148 which allow the compressor discharge air 36 flowing from the apertures 118 (FIG. 6) defined in the inner pipe 110 to exhaust into the opening 108.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A compressor inlet housing, comprising:
a bleed heat duct assembly disposed within the compressor inlet housing, the bleed heat duct assembly comprising;
a duct having a plurality of walls defining an opening, wherein the duct includes a slot defined along a wall of the plurality of walls;
a bleed air manifold;
a plurality of feed pipe assemblies disposed at least partially within the opening and in fluid communication with the bleed air manifold, each feed pipe assembly of the plurality of feed pipe assemblies including an inner pipe having an upstream end connected to the bleed air manifold and defining a plurality of apertures, a cap sealingly connected to a downstream end of the inner pipe and a pin that extends outwardly from the cap, wherein the pin extends into the slot, and wherein the inner pipe is at least partially wrapped with a noise attenuating material at least partially disposed within an outer sleeve, wherein the noise attenuating material covers at least a portion of the apertures of the plurality of apertures.

2. The compressor inlet housing as in claim 1, wherein the slot is oriented laterally with respect two parallel walls of the plurality of walls of the duct.

3. The compressor inlet housing as in claim 1, wherein the slot is defined by a plate connected to the wall of the plurality of walls.

4. The compressor inlet housing as in claim 1, wherein the bleed air manifold is disposed outside of the opening of the duct.

5. The compressor inlet housing as in claim 1, wherein the bleed air manifold is disposed within the opening of the duct.

6. The compressor inlet housing as in claim 1, wherein the bleed heat duct assembly further comprises a housing coupled to the wall of the plurality of walls, wherein the pin extends into the housing.

7. The compressor inlet housing as in claim 1, wherein the bleed air manifold is fixed in position at one end and unrestrained at a second end.

8. The compressor inlet housing as in claim 1, wherein a first set of feed pipe assemblies of the plurality of feed pipe assemblies extends upwardly from the bleed air manifold and a second set of feed pipe assemblies of the plurality of feed pipe assemblies extend downwardly from the bleed air manifold.

9. The compressor inlet housing as in claim 1, wherein the plurality of apertures of each inner pipe provides for fluid communication between the bleed air manifold, through the noise attenuating material and into the opening of the duct.

10. The compressor inlet housing as in claim 1, wherein the outer sleeve is decoupled from the transient thermal growth of both the inner pipe and the pipe header.

11. A compressor inlet housing, comprising:
a bleed heat duct assembly disposed within the compressor inlet housing, the bleed heat duct assembly comprising;
a duct having a plurality of walls defining an opening, wherein the duct includes a slot defined along a wall of the plurality of walls;
a bleed air manifold;
a plurality of feed pipe assemblies disposed at least partially within the opening and in fluid communication with the bleed air manifold, each feed pipe assembly of the plurality of feed pipe assemblies including an inner pipe having an upstream end connected to the bleed air manifold and defining a plurality of apertures, and a cap sealingly connected to a downstream end of the inner pipe;
an outer sleeve that surrounds at least the downstream end of the of the feed pipe assembly, the outer sleeve having an end plate and a pin that extends outwardly from the end plate, wherein the pin extends into the slot, wherein the inner pipe is at least partially wrapped with a noise attenuating material at least partially disposed within the outer sleeve, wherein the noise attenuating material covers at least a portion of the apertures of the plurality of apertures.

12. The compressor inlet housing as in claim 11, wherein the slot is oriented laterally with respect two parallel walls of the plurality of walls of the duct.

13. The compressor inlet housing as in claim 11, wherein the slot is defined by a plate connected to the wall of the plurality of walls.

14. The compressor inlet housing as in claim 11, wherein the bleed air manifold is disposed outside of the opening of the duct.

15. The compressor inlet housing as in claim 11, wherein the bleed air manifold is disposed within the opening of the duct.

16. The compressor inlet housing as in claim 11, wherein the bleed heat duct assembly further comprised a housing coupled to the wall of the plurality of walls, wherein the pin extends into the housing.

17. The compressor inlet housing as in claim 11, wherein the bleed air manifold is fixed in position at one end and unrestrained at a second end.

18. The compressor inlet housing as in claim 11, wherein a first set of feed pipe assemblies of the plurality of feed pipe assemblies extend upwardly from the bleed air manifold and a second set of feed pipe assemblies of the plurality of feed pipe assemblies extend downwardly from the bleed air manifold.

19. The compressor inlet housing as in claim 11, wherein each inner pipe defines a plurality of apertures that provide for fluid communication between the bleed air manifold and the opening of the duct and wherein the inner pipe is at least partially wrapped with a noise attenuating material that covers at least a portion of the apertures of the plurality of apertures.

20. The compressor inlet housing as in claim 11, wherein the outer sleeve is decoupled from the transient thermal growth of both the inner pipe and the pipe header.
